(19) United States
(12) Patent Application Publication
(10) Pub. No.: US 2017/0041927 A1
(43) Pub. Date: Feb. 9, 2017

(54) METHOD FOR TRANSMITTING AND RECEIVING BEACON SIGNAL BASED ON MULTI-CHANNELS AND DEVICE SUPPORTING THEREFOR

(71) Applicant: ELECTRONICS AND TELECOMMUNICATIONS RESEARCH INSTITUTE, Daejeon (KR)

(72) Inventors: Wun Cheol JEONG, Daejeon (KR); Ho Yong KANG, Daejeon (KR)

(21) Appl. No.: 15/218,262

(22) Filed: Jul. 25, 2016

(30) Foreign Application Priority Data
Aug. 4, 2015 (KR) 10-2015-0110135

(51) Int. Cl. H04W 72/04; H04W 74/08; H04W 56/00; H04W 72/00

(52) U.S. Cl. CPC H04W 72/0446; H04W 72/005; H04W 74/0816; H04W 72/0453; H04W 56/001

(57) ABSTRACT

A method for transmitting and receiving a beacon packet based on multi-channels and a device supporting therefor which generate a beacon packet according to a scheduled super frame by a device, attempt broadcasting of the beacon packet in a beacon slot period of a super frame to a channel set in the super frame, verify whether the set channel is occupied by another device in the beacon slot period, reattempt broadcasting of the beacon packet to the set channel in another predetermined super frame when the set channel is occupied by another device in the beacon slot period, and update a p value according to whether the beacon packet is successfully broadcasted by a transmission probability p value (0<p<1) of a p-persistent CSMA-CA method.

### CROSS-REFERENCE TO RELATED APPLICATIONS

This application claims priority to and the benefit of Korean Patent Application No. 10-2015-0110135 filed in the Korean Intellectual Properly Office on Aug. 4, 2015, the entire contents of which are incorporated herein by reference.

### BACKGROUND

1. Field of the Invention

Various exemplary embodiments of the present invention relate to a method for transmitting and receiving a beacon signal based on multi-channels in a time-division based wireless network system and a device supporting therefor.

2. Description of Related Art

In recent years, in order to implement a low-power capability under a multi-hop environment in a distributed wireless network system such as a sensor network or a wireless personal area network (WPAN) constituted by node devices having limited resources and in order to provide an application service in which one-time delivery is paramount, a time-division transmission scheme in which it is possible to predict a transfer time is preferred rather than a predetermined channel access scheme in which it is difficult to predict the transfer time.

In general, in the time-division based transmission scheme, a beacon signal having time stamp information is periodically broadcasted and a device which receives the beacon signal corrects a clock thereof based on received time information and broadcasts the beacon signal including the corrected time information, and the devices constituting the network system repeatedly correct the clock and broadcast the beacon signal to perform time synchronization among the node devices.

### SUMMARY OF THE INVENTION

In a delayed beacon transmission scheme in the related art, with deterioration of the quality of a wireless channel or an increase in the number of surrounding devices, the number of transmission delays exponentially increases and a transmission failure of some packets may occur, and as a result, a significant problem may occur in time synchronization.

Various exemplary embodiments of the present invention relate to a method for transmitting and receiving a beacon signal based on multi-channels and a device supporting therefore which are capable of solving the problems. Further, the method for transmitting and receiving a beacon signal based on multi-channels is to provide a computer readable recording medium having a program for execution in a computer recorded therein. However, objects which various exemplary embodiments of the present invention intend to achieve are not limited to the abovementioned object and other objects may be present.

An exemplary embodiment of the present invention provides a method for transmitting and receiving a beacon packet based on multi-channels, including: generating a beacon packet according to a scheduled super frame by a device, attempting broadcasting of the beacon packet in a beacon slot period of a super frame to a channel set in the super frame, verifying whether the set channel is occupied by another device in the beacon slot period, reattempting broadcasting of the beacon packet to the set channel in another predetermined super frame when the set channel is occupied by another device in the beacon slot period, and updating a p value according to whether the beacon packet is successfully broadcasted by a transmission probability p value (0<p<1) of a p-persistent CSMA-CA method.

According to exemplary embodiments of the present invention, a method for transmitting and receiving a beacon signal based on multi-channels and a device supporting therefor can increase rigidity For interference among surrounding devices under a wireless network environment in which a density of node devices is high and improve a capability of pricket transmission through changing a frequency channel when the quality of a wireless channel deteriorates. As a result in a wireless network system, distributed full-band time synchronization among the devices can be implemented and a low-power capability can be improved.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIGS. 1A to 1C illustrate a network embodiment in which a beacon signal is broadcasted.

FIG. 2 illustrates an available frequency band and a frequency channel which can be used in a device according to various exemplary embodiments of the present invention.

FIG. 3 is a diagram illustrating a structure of a super frame for transmitting a beacon packet according to various exemplary embodiments of the present invention.

FIG. 4 is a diagram illustrating a beacon packet according to various exemplary embodiments of the present invention.

FIG. 5 is a diagram for describing an operation of a device which performs beacon broadcasting by using a multi-channel list and a super frame according to various exemplary embodiments of the present invention.

FIG. 6 is a diagram for describing a scan process for searching an initial network in a device according to various exemplary embodiments of the present invention.

FIG. 7 is a diagram for describing a beacon broadcasting process in a device according to various exemplary embodiments of the present invention.

FIG. 8 is a diagram for describing a beacon listening process in a device according to various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, various exemplary embodiments of the present invention will be described in detail in reference to the drawings. In this case, like reference numerals refer to like elements in the respective drawings. Further, a detailed description of an already known function and/or configuration will be skipped. In contents disclosed hereinbelow, a part required for understanding art operation according to various exemplary embodiments will be described in priority and a description of elements which may obscure the spirit of the present invention will be skipped.

Further, terms such as first, second, A, B, (a), (b), and the like may be used in describing the elements of the exemplary embodiments of the present invention. The terms are only used to distinguish an element from another element, but nature or an order of the element is not limited by the terms.

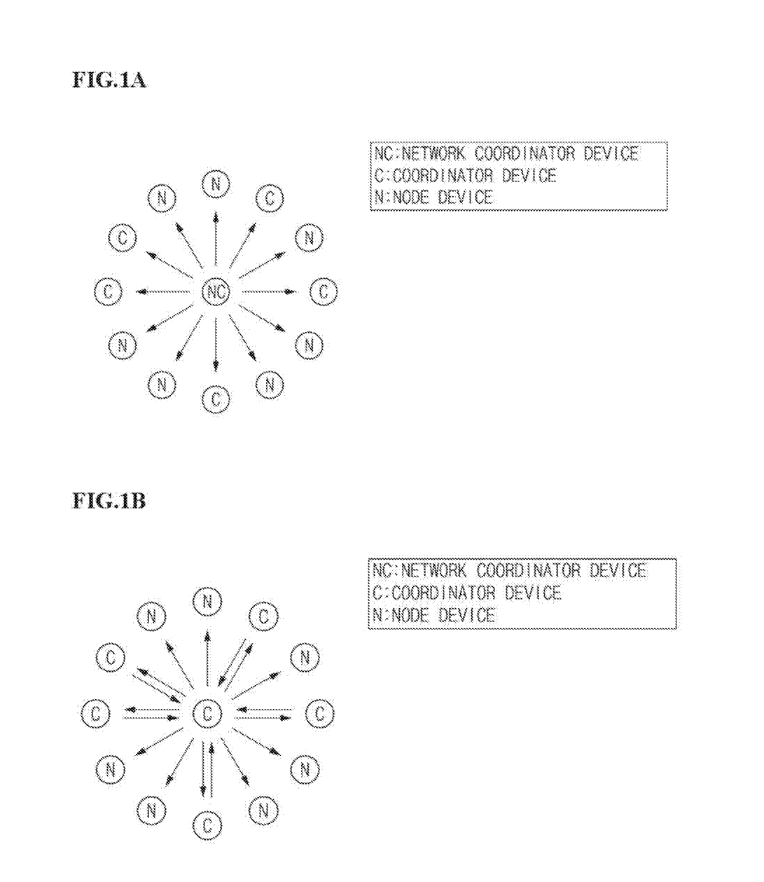

FIGS. 1A to 1C illustrate a network environment in which a beacon signal is broadcasted.

Devices consulting a network may be logically constituted by three devices of a network coordinator device, a coordinator device, and a node device. The device according to the exemplary embodiment may include electronic devices including a sensor, a cellular phone, a smart phone, a notebook computer, a digital broadcasting terminal, a digital camera, a portable game terminal, personal digital assistants (PDA), a portable multimedia player (PMP), a navigation, a tablet personal computer (PC), and the like. Further, the device may include various types of wearable electronic devices including a smart watch, a smart glass, an electronic bracelet, an electronic anklet, an electronic necklace, an electronic ring, an electronic belt, and the like. The device is not limited thereto and the device may include all of an information communication device, a multimedia device, and application devices thereof.

FIG. 1A illustrates a network coordinator device. The network coordinator device may initially periodically broadcast the beacon signal to the device which starts a network configuration. For example, only one network coordinator device may be present in a network which is operated.

FIG. 1B illustrates a coordinator device. The coordinator device may correct a clock thereof by using time information included in a beacon packet from a network coordinator device or another coordinator device and periodically broadcast the beacon signal by containing the corrected time information in the beacon packet.

FIG. 1C illustrates a node device. The node device may correct a clock thereof by using the time information included in the beacon packet from the network coordinator device or another coordinator device to a device which does not broadcast the beacon signal.

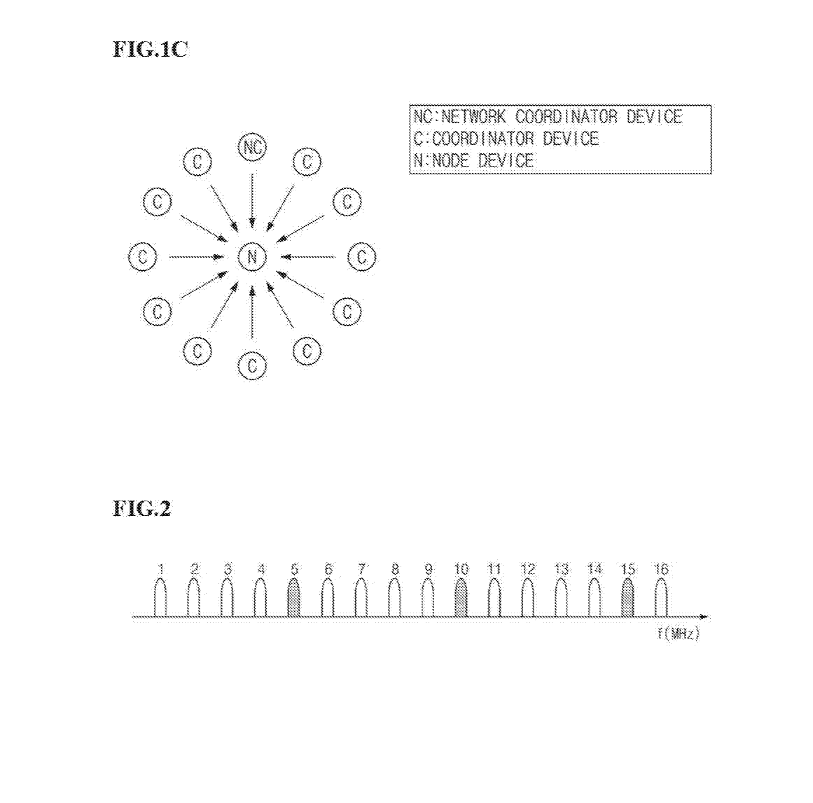

FIG. 2 illustrates an available Frequency hand and a frequency channel which can be used in a device according to various exemplary embodiments of the present invention.

The available frequency band and the frequency channel illustrated in FIG. 2 are just an example and the available frequency band the frequency channel which may be used in the device are not limited thereto.

In the example illustrated in FIG. 2, the device of the wireless network system may use 16 frequency channels. The device of the wireless network system may use some of 16 frequency channels as the frequency channel for broadcasting the beacon signal. For example, the device may use frequency channels displayed with a shadow in FIG. 2, that is, channel 5, channel 10, and channel 15 as the frequency channels for broadcasting the beacon signal. Each device of the wireless network system may store the frequency channels as a multi-channel list for beacon broadcasting. For example, the multi-channel list may be stored in a storage device such as an internal memory of each device. In this case, the multi-channel list may indicate an ordered channel list in which the selected frequency channels selected for the beacon broadcasting among the available frequency channels defined for wireless communication are arranged in order in the wireless network system. In this case, the order of the frequency channels included in the multi-channel list may vary depending on the device, but the frequency channels constituting the multi-channel list are the same as each other in all devices of the wireless network system.

According to the exemplary embodiment, all devices of the wireless network system may have the same common control channel. The common control channel may correspond to a basic frequency channel for beacon broadcasting and beacon reception. For example, in the example illustrated in FIG. 2, the respective devices of the wireless network system may use channel 10 as the common control channel and in the multi-channel list of each device, channel 10 may be displayed as the common control channel.

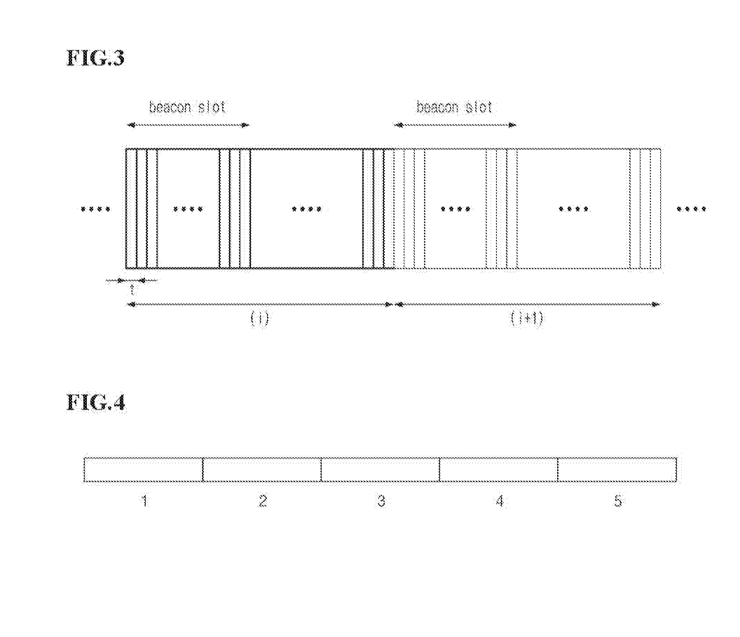

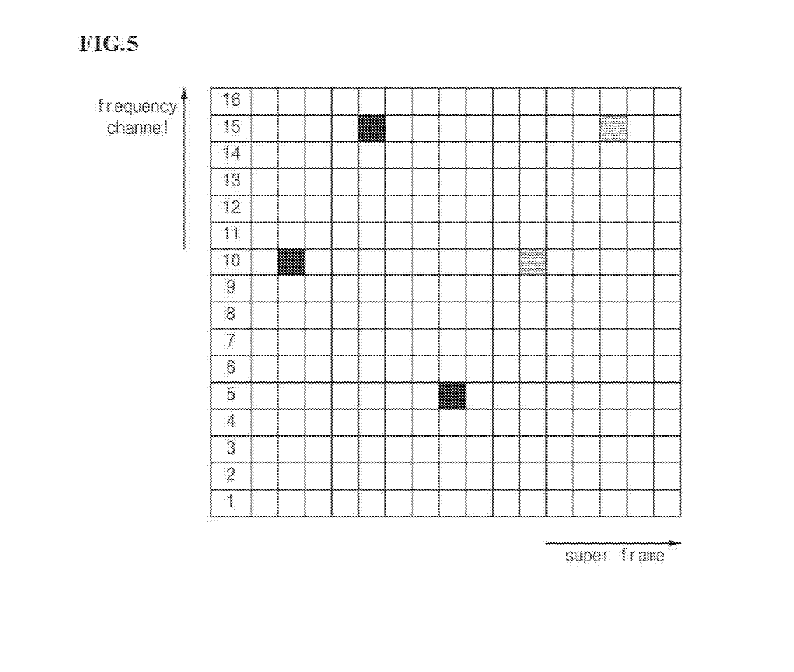

FIG. 3 is a diagram illustrating a structure of a super frame for transmitting a beacon packet according to various exemplary embodiments of the present invention.

FIG. 3 illustrates a timing structure for transmitting the beacon packet and is configured by a unit slot time t. Referring to FIG. 3, (i) represents an i-th super frame and (i+1) represents an i+1-th super frame. For easy description, FIG. 3 illustrates only two super frames, but the present invention is not limited thereto. The time unit of the super frame structure may be configured by a unit slot time defined as a time corresponding to integer times of a transmission symbol time. According to this, a transmission time of all packets may be represented as the integer times of the unit slot time from a start time of the super frame.

In FIG. 3, the super frame (i) starts as a beacon slot period for the beacon broadcasting and the beacon reception. In the super frame (i), residual periods other than the beacon slot may be used as periods for maintaining or managing the network and exchanging a data packet. The beacon packet needs to be broadcasted in the beacon slot and transmission of the beacon packet starts and ends within the beacon slot period. According to the structure of the super frame, each device of the wireless network system may perform channel access.

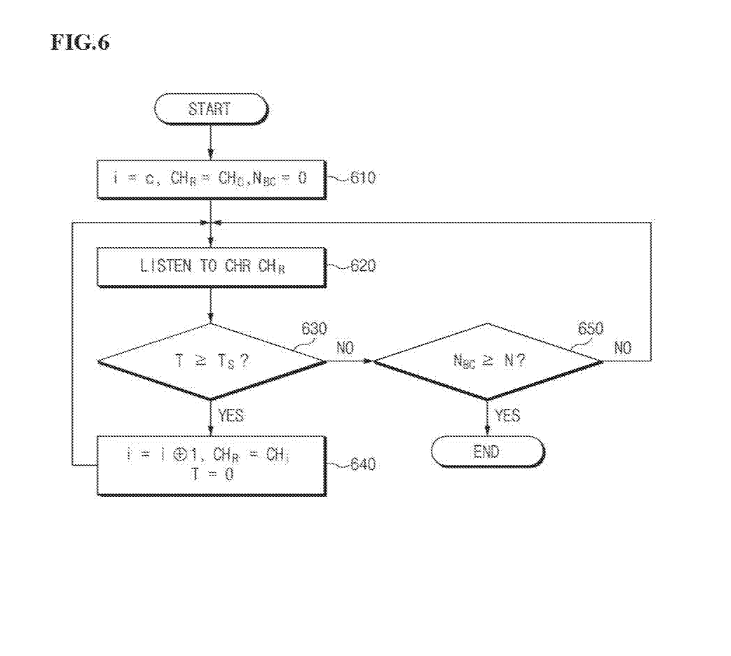

FIG. 4 is a diagram illustrating a beacon packet according to various exemplary embodiments of the present invention.

The beacon packet illustrated in FIG. 4 is just one example. According to various exemplary embodiments of the present invention, the order of the respective fields of the beacon packets may vary and the beacon packet may further include other information other than the field illustrated in FIG. 4.

Reference numeral 1 represents a frequency channel number field. The frequency channel number field may represent a frequency channel number positioned next to a frequency channel number used for current beacon broadcasting in the multi-channel list. That is, the frequency channel number field represents a frequency channel number to be used for the beacon broadcasting during the beacon slot period of the super frame scheduled for next beacon broadcasting.

Reference numeral 2 represents a beacon broadcasting schedule field. The beacon broadcasting schedule field may have a positive integer value and represent how many super frames the next beacon broadcast is attempted in from the current super frame.

Reference numeral 3 represents a time information field. The time information field as a full-band time value used in the wireless network system represents a full-band time value of the wireless network system obtained through time information of a previously received beacon packet and a predicted full-band time value at a beacon broadcasting time predicted by using clock value of the device, which is corrected through the full-band time value.

Reference numeral 4 represents a super frame field. The super frame field is a value representing the length of the super frame. For example, the super frame field may be the length of the super frame (i) of FIG. 3.

Reference numeral 5 represents a beacon slot. A beacon slot field is a value representing the length of the beacon slot period of the super frame. For example, the beacon slot field may be the length of the beacon slot period of the super frame (i) of FIG. 3.

The transmission of the beacon packet may start by the network coordinator device. The network coordinator device may start broadcasting the beacon packet at a beacon slot start time of the super frame by containing information required for the network configuration in each field of the beacon packet. According to this, the network coordinator device may start the beacon broadcasting through the frequency channel scheduled at the time of the beacon slot start time of the super frame specified in the beacon broadcasting schedule field, that is, the value of the frequency channel number field and this process may be repeated. As a channel for initial beacon broadcasting, the common control channel may be used and in subsequent beacon broadcasting, the frequency channel described next to the common control channel of the multi-channel list may be used. After a last frequency channel of the multi-channel list is used, a first frequency channel of the multi-channel list may be cyclically and repeatedly used, first of all.

FIG. 5 is a diagram for describing an operation of a device which performs beacon broadcasting by using a multi-channel list and a super frame according to various exemplary embodiments of the present invention.

FIG. 5 is just one example in which the device performs the beacon broadcasting and the present invention is not limited thereto. In the example of FIG. 5, the device may have the multi-channel list constituted by three channels of channel 5, channel 10, and channel 15 and a beacon broadcasting period of 3 super frame periods. Channel 10 may be used as the common control channel in the wireless network system to which the device belongs.

When a leftmost super frame of FIG. 5 is a first super frame, the device may perform the initial beacon broadcasting through common control channel 10 in a second super frame. In this case, in the broadcasted beacon packet, the frequency channel number field value pay be 0h0F (15 as a decimal number) representing channel 15 for the next beacon broadcasting and the beacon broadcasting schedule may be 0h03 (3 as the decimal number) which is the beacon broadcasting period. According to the beacon broadcasting period, the device may perform the beacon broadcasting through scheduled channel 15 in a 5-th super frame. In this case, the frequency channel number field value of the broadcasted beacon packet may be 0h05 (5 as the decimal number) representing the channel for the next beacon broadcasting, that is, channel 5 which is an initial value of the multi-channel list and the beacon broadcasting schedule may be 0h03 (3 as the decimal number) which is the beacon broadcasting period. As described above, as the frequency channels used tor the beacon broadcasting, channels arranged in the multi-channel list may be cyclically used in order.

FIG. 6 is a diagram for describing a scan process for searching an initial network in a device according to various exemplary embodiments of the present invention.

According to various exemplary embodiments, the coordinator device and the node device may perform a scan process for searching the network, which is described below.

In step 610, the device may configure a receiving channel. For example, the device may set a receiving channel CH_{R} as a common control channel CH_{C} and 0 as the number N_{BC} of successfully received beacons. Further, index i may be set as index c. In this case, the index i represents an i-th frequency channel of the multi-channel list and the index c represents a common control channel frequency.

In step 620, the device may listen to the set receiving channel CH_{R}. In step 630, the device may verify whether a scan timer T (a timer value using an internal clock) passes a predetermined time Ts. When the scan timer T passes the predetermined scan time Ts, the device may proceed to step 640 and otherwise, the device may proceed to step 650.

In step 640, until the receiving channel is changed according to the multi-channel list and thereafter, the number N_{BC} of successfully received beacons reaches a target beacon packet number n, the device may receive the beacon packet.

For example, the device adds the index i representing the frequency channel of the multi-channel list with the length L of the multi-channel list (in this case, an add operator ⊕ may represent an add operator of an L-module) and configures the receiving channel CH_{R} as an i-th frequency channel value CHᵢ of the multi-channel list to change the frequency channel. The device may reset the scan timer T to 0. Further, since the device resets the receiving channel, the device may reset N_{BC} to 0. As a result, the number of beacons received through listening in a newly set channel may be newly counted.

That is, when it is sensed that the channel is occupied by another device, the device that performs the scan may repeat the scan process by changing the corresponding channel to another frequency channel of the multi-channel list.

In step 660, the device may verify whether the number N_{BC} of successfully received beacons is equal to or more than the target beacon packet number n. When the number N_{BC} of successfully received beacons is equal to or more than the target beacon packet number n, the device may end the scan process and otherwise, the device may return to step 620 again.

That is the device may perform the scan until receiving n beacon packets by listening to the common control channel. Since n is a predetermined positive integer value set by the device, n may correspond to the minimum number of beacon packets required for estimating a network full-band time. In this case, since the n value depends on components constituting the device, n may have different values depending on a manufacturer. Further, a recessing device may predict a network full-band time value by using ‘time information’ field values of n beacon packets and correct a clock thereof by using the predicted network full-band time value.

The device may perform the scan process described above and perform the network search. When the network search is completed through the scan process, the device may obtain full-band time synchronization between the devices by repeating broadcasting and listening of the beacon packet.

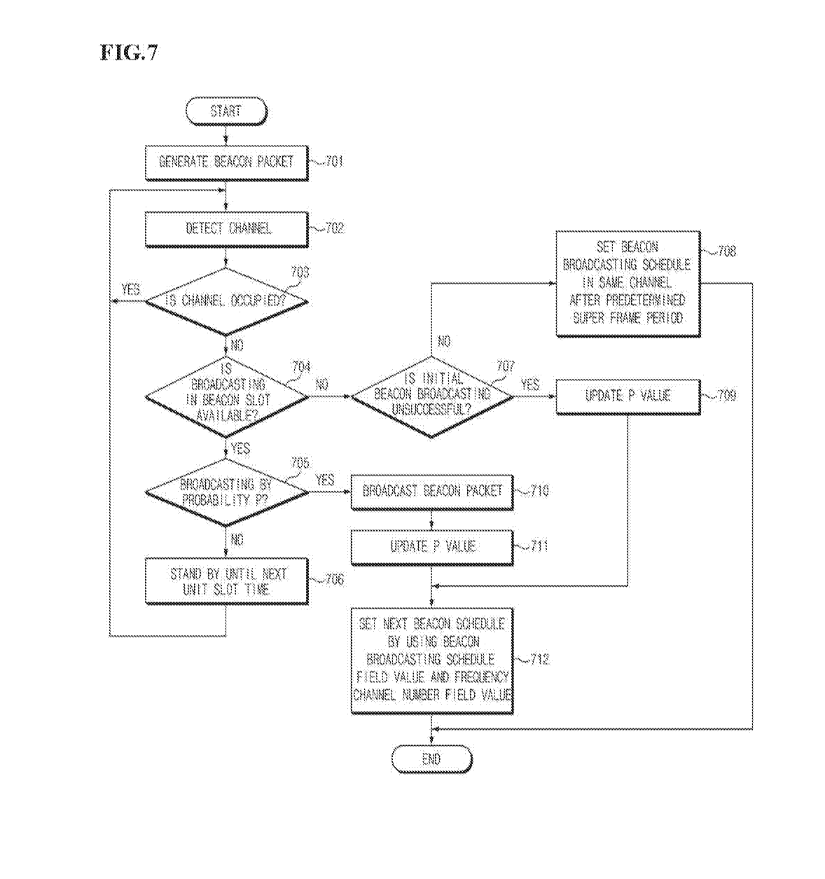

FIG. 7 in a diagram for describing a beacon broadcasting process in a device according to various exemplary embodiments of the present invention.

The coordinator device may schedule the super frame for the beacon broadcasting by using the super frame information obtained through the scan process.

In step 701, the device may generate the beacon packet. When the scheduled super frame arrives, the device may generate a beacon frame for the beacon broadcasting.

In step 702, the device may detect the channel. The initial beacon broadcasting may be performed at a slot period start point of the corresponding super frame and attempted in the common control channel of the multi-channel list. The device may access the channel by using a p-persistent carrier sense multiple access with collision avoidance (CSMA-CA) method.

In step 703, the device may verify whether other devices occupy the channel in the corresponding beacon slot period. When it is verified that the other devices occupy the channel, the device may perform step 702 again. Otherwise, the device proceeds to step 704.

In step 704, the device may verify whether broadcasting is available in the beacon slot. When the broadcasting is available in the beacon slot, the device may proceed to step 705 and otherwise, the device may proceed to step 707.

In step 705, the device may verify whether the broadcasting corresponds to broadcasting by a probability p. When the broadcasting corresponds to the broadcasting by the probability p, the device may proceed to step 710 and otherwise, the device may proceed to step 706.

In step 706, the device may stand by until a next unit slot time.

In step 707, the device may verify whether unsuccessful broadcasting is a first broadcasting attempt of the corresponding beacon packet. When the unsuccessful broadcasting is the first broadcasting attempt, the device may proceed to step 708 and otherwise, the device may proceed to step 709.

In step 708, when the unsuccessful broadcasting is the first broadcasting attempt of the corresponding beacon packet, the device may set a beacon broadcasting schedule in the same channel after a predetermined super frame period. That is the device may attempt the beacon broadcasting by using the p-persistent CSMA-CA. method in the same frequency channel by scheduling another predetermined super frame.

In step 709, when the unsuccessful broadcasting is not the first broadcasting attempt of the corresponding beacon packet, a value of a transmission probability p may be updated to a value which is larger than the current set p value, however, smaller than 1.

In step 710, the device may perform the beacon broadcasting.

In step 711, when the beacon broadcasting is successful, the device may update the value of the transmission probability p to a value which is smaller than the current set p value, however, larger than 0.5.

In step 712, the device may set a next beacon schedule using the beacon broadcasting schedule field value and the frequency channel number field value.

As described above, when the initial beacon broadcasting is achieved, the device may attempt the broadcasting through the frequency channel set in the frequency channel number field in the beacon slot period of the super frame corresponding to the beacon broadcasting schedule field value of the beacon packet.

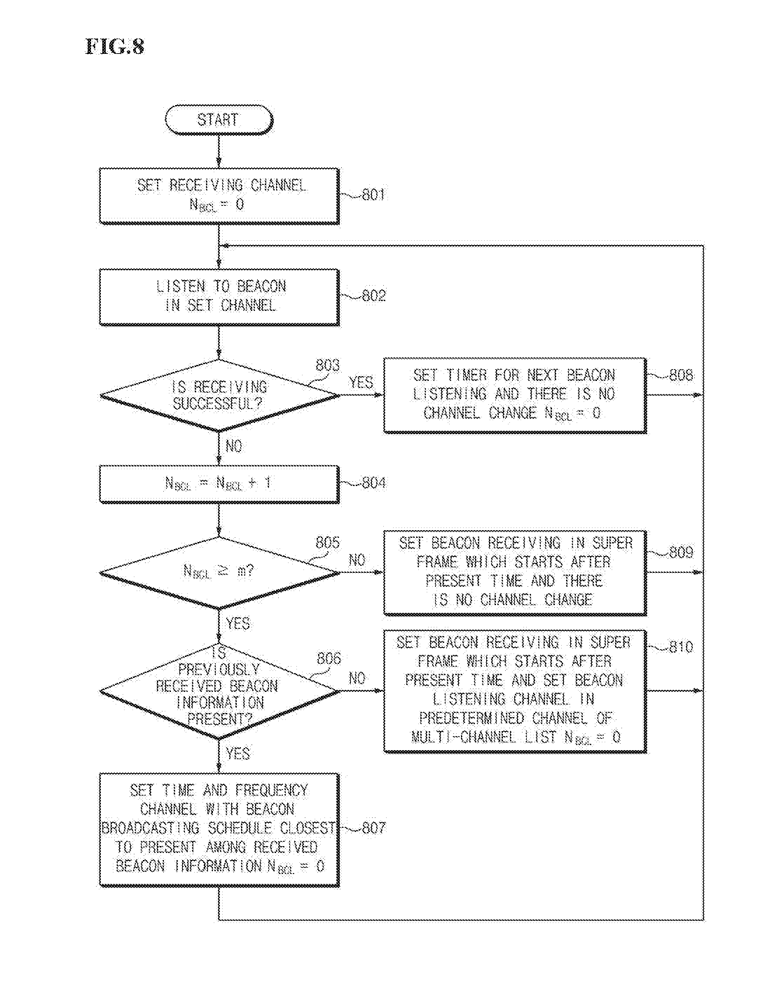

FIG. 8 is a diagram for describing a beacon listening process in a device according to various exemplary embodiments of the present invention.

According to various exemplary embodiments, the coordinator device and the node device may perform a beacon listening process described below.

In step 801, the device may set the receiving channel. Further, the device may set N_{BCL}, the number of times of unsuccessful beacon reception to 0. For example, the device may set an initial receiving channel as the common control channel during the listening process.

In step 802, the device may perform the beacon listening in the set channel. The coordinator device may selectively listen to a beacon broadcasted by another coordinator device or network coordinator in residual super frames other than the super frame for the beacon broadcasting. The node device may selectively listen to the beacon broadcasted by another coordinator device or network coordinator in all super frames.

In step 803, the device may verify whether the beacon packet is successfully received. When the beacon packet is successfully received, the device may proceed to step 804 and when the beacon packet is unsuccessfully received, the device may proceed to step 808.

In step 804, the device may add 1 to N_{BCL}, the number of times of unsuccessful beacon reception.

In step 805, the device may verify whether N_{BCL}, the number of times of unsuccessful beacon reception is equal to or more than m, the number of times of unsuccessful consecutive beacon reception when maintaining full-band time synchronization is predicted to be impossible. When N_{BCL}, the number of times of unsuccessful beacon reception is equal to or more than m, the number of times of unsuccessful consecutive beacon reception, the device may proceed to step 806 and otherwise, the device may proceed to step 809. In this case, m as a predetermined positive integer value set by the device may correspond to the maximum number of times of unsuccessful beacon listening, which is required for the device to estimate the network full-band time by considering a clock drift which occurs when the beacon is unsuccessfully received. Since the m value depends on a beacon listening period and the components constituting the device, the m value may have different values depending on the manufacturer.

When the corresponding channel is occupied by another device and the beacon is unsuccessfully listened in m consecutive beacon slot periods according to a beacon listening schedule, the device determines that the quality of the corresponding channel deteriorates to attempt changing the receiving channel.

In step 806, the device may verify whether previously received beacon information is present. When the previously received beacon information is present, the device may proceed to step 807 and otherwise, the device may proceed to step 810.

In step 807, the device may set a time and a frequency channel with a beacon broadcasting schedule closest from the present among the received beacon information and set N_{BCL}, the number of times of unsuccessful beacon reception to 0.

The device may verify whether the previously received beacon packet is present in a received beacon information list. When the previously received beacon packet is present in the received beacon information list, the beacon slot period of the super frame which comes earliest at the present time and a used frequency channel in the corresponding period are set by verifying the beacon schedule of the device which broadcasts the received beacon to listen to the beacon. Thereafter, the beacon may be listened in the corresponding frequency channel. When the beacon is unsuccessfully listened in the m beacon slot periods, the process may be repeated.

In step 808, the device may set a timer for listening to a next beacon. In this case, the channel may not be changed and the device may set N_{BCL}, the number of times of unsuccessful beacon reception to 0.

In step 809, the device may set the beacon reception in the super frame which starts after the present time and set a beacon listening channel as a predetermined channel of the multi-channel list. Further, the device may set N_{BCL}, the number of times of unsuccessful beacon reception to 0.

In step 810, the device may set a time and a frequency channel with a beacon broadcasting schedule closest from the present among the received beacon information and set N_{BCL}, the number of times of unsuccessful beacon reception to 0. When the previously received beacon information is not present in the received beacon information list, the frequency channel for listening to the beacon is changed to a frequency channel described next to the common control channel of the multi-channel list to attempt listening to the beacon.

When the beacon is not unsuccessfully listened consecutively m times, the beacon is continuously listened in the set channel without changing the channel and when the beacon is unsuccessfully listened consecutively m times, the device may change the listening channel.

The device may predict the network full-band time valise by using time information field values of n beacon packets obtained through the listening process and correct the clock thereof by using the predicted network full-band time value. In this case, the device may use various algorithms widely used for the clock correction, which include a primary linear regression method, and the like.

The device constituting the network may recover the full-band time synchronization by repeating the scan process, the broadcasting process, and the listening process when it is difficult to maintain the full-band time synchronization due to other reasons including the unsuccessful beacon listening. Further, even when the device changes a device function, the full-band time synchronization may be obtained by repeating the processes. Changing the device function may include, for example, a case of changing a function from the node device to the coordinator device or contrary to this, from the network coordinator device to a device type having a different function. After the device is reset by a request by a user, the device may be changed to a device having a different function.

Steps of a method or an algorithm described in association with the exemplary embodiments disclosed in the specification may be directly implemented by hardware and software modules executed by the processor, or a combination thereof. The software module may reside in a RAM, a flash memory, a ROM, an EPROM, an EEPROM, a register, a hard disk, a removable disk, and a CD-ROM or a predetermined other type of storage medium known in the art. The exemplary storage medium is coupled to the processor and the processor may read information from the storage medium and write the information in the storage medium. As another method, the storage medium may integrated with the processor. The processor and the storage medium may reside in an application specific integrated circuit (ASIC). The ASIC may reside in the user terminal. As yet another method, the processor and the storage medium may reside in the user terminal as individual components.

All exemplary embodiments and conditional examples disclosed in the present specification are just exemplarily described in order to help those skilled in the art to understand a principle and a concept of the present invention, and it can be understood by those skilled in the art that the present invention can be implemented in a modified form without departing from the essential characteristic of the present invention. Therefore, the disclosed exemplary embodiments should be considered from not a limitative viewpoint but an explanatory viewpoint. The scope of the present invention is described in not the above description but the appended claims, and it should be analyzed that all differences within a scope equivalent thereto are included in the present invention.

What is claimed is:

1. A method for transmitting and receiving a beacon packet based on multi-channels, the method comprising:
generating, by a device, a beacon packet according to a scheduled super frame;
verifying whether the set channel is occupied by another device in a beacon slot period;
attempting broadcasting the beacon packet in the beacon slot period of the super frame to the channel set in the super frame based on a multi-channel list in which frequency channels allocated to beacon broadcasting are arranged in sequence when the set channel is not occupied by another device; and
updating the p value according to whether the beacon packet is successfully broadcasted by a transmission probability p value (0<p<1) of a p-persistent CSMA-CA method.

2. The method of claim 1, further comprising:
setting the channel so that the frequency channels in the multi-channel list are circulated in sequence according to the scheduling of the super frame based on the multi-channel list.

3. The method of claim 1, wherein the multichannel list includes a common control channel, and
the device attempts broadcasting by using the common control channel during initial beacon broadcasting.

4. The method of claim 1, wherein when the beacon packet is successfully broadcasted, the p value is updated to a p value which is smaller than a current p value and larger than 0.5.

5. The method of claim 1, wherein when the beacon packet is unsuccessfully broadcasted and when the unsuccessful broadcasting is not a first broadcasting attempt of the beacon packet, the p value is updated to a p value which is larger than the current set p value and smaller than 1.

6. The method of claim 1, wherein when the beacon packet is unsuccessfully broadcasted and when the unsuccessful broadcasting is the first broadcasting attempt of the beacon packet, the beacon broadcasting schedule is set in the same channel after a predetermined super frame period.

7. The method of claim 1, wherein the beacon packet includes at least one of a frequency channel number for next beacon broadcasting, a super frame scheduled for the next beacon broadcasting, a predicted full-band time value, the length of the super frame, and the length of the beacon slot period in the super frame.

8. The method of claim 1, further comprising:
setting, by the device, the frequency channel number for the next beacon broadcasting and a schedule of the nest beacon broadcasting.

9. The method of claim 1, wherein in the attempting of the broadcasting of the beacon packet, when the device is a coordinator device, the device corrects a clock thereof and generates the beacon packet including the corrected time information, based on a beacon packet received by broadcasting by a network coordinator device or another coordinator device.

10. The method of claim 1, further comprising:
performing scanning for searching a network,
wherein the scanning includes
listening, by the device, to the beacon packet broadcasted by another device in a set listening channel,
listening to the beacon packet by the another device for a designated scan time,
changing the listening channel based on the multi-channel list in which the frequency channels allocated to listening to the beacon packet are arranged in sequence when the designated scan time elapses, and
searching the network based on the beacon packet obtained through the listening.

11. The method of claim 10, wherein the device repeats the scanning until obtaining a minimum number of beacon packets required for estimating a network full-band time.

12. The method of claim 1, further comprising:
listening, by the device, to the beacon packet broadcasted by another device,
wherein the listening includes
setting the listening channel,
listening to the beacon packet broadcasted by the another device in the set listening channel, and
setting a timer for listening to a next beacon packet when the beacon packet is received from the another device through the listening.

13. The method of claim 12, wherein the listening further includes,
when the beacon packet is not received from the another device, determining, by the device, whether the number of times of unsuccessful consecutive reception of the beacon packet when the beacon packet is unsuccessfully received is equal to or more than the number of unsuccessful receptions when maintaining full-band time synchronization is predicted to be impossible, and
changing, by the device, the set listening channel when the number of times of unsuccessful consecutive reception of the beacon packet is equal to or more than the number of unsuccessful reception when maintaining full-band time synchronization is predicted to be impossible.

14. The method of claim 13, wherein the device listens to the beacon packet broadcasted by the another device in the set listening channel in the super frame which starts after the present time when the number of times of unsuccessful consecutive reception of the beacon packet is less than the number of unsuccessful reception that maintaining full-band time synchronization is predicted to be impossible.

15. The method of claim 13, wherein the changing of the set listening channel includes:
verifying whether a beacon packet previously received by the another device present, and
changing the set listening channel based on a schedule and a frequency channel of the beacon broadcasting by the another device obtained from information on the previously received beacon packet when the beacon packet previously received by the another device is present.

16. The method of claim 15, wherein in the changing of the set listening channel, the set listening channel is changed based on the multi-channel list in which the frequency channels allocated to listening to the beacon packet are arranged in sequence when the beacon packet previously received by the another device is not present.
